(19) United States
(12) Patent Application Publication
(10) Pub. No.: US 2025/0274216 A1
(43) Pub. Date: Aug. 28, 2025

(54) METHODS, COMMUNICATIONS DEVICE, AND INFRASTRUCTURE EQUIPMENT

(71) Applicant: Sony Group Corporation, Tokyo (JP)

(72) Inventor: Shin Horng WONG, Basingstoke (GB)

(73) Assignee: Sony Group Corporation, Tokyo (JP)

(21) Appl. No.: 18/858,351

(22) PCT Filed: Mar. 30, 2023
(86) PCT No.: PCT/EP2023/058319

§ 371 Date: Oct. 21, 2024

(30) Foreign Application Priority Data
Apr. 28, 2022 (EP) 22170653.4

(51) Int. Cl. H04L 1/00; H04W 72/044

(52) U.S. Cl. CPC H04L 1/0003; H04W 72/044

(57) ABSTRACT

A method for operating infrastructure equipment in a wireless communications network involves managing data transmissions with a device through time and frequency resources of a wireless access interface. The method includes determining when to transmit or receive data and dividing the transmission into at least two portions. Each portion uses different time and frequency resources, with the first portion utilizing a distinct modulation and/or coding scheme compared to the second portion. The infrastructure equipment ensures that both portions are communicated using their respective modulation and coding schemes. This allows efficient handling of wireless data transmissions.

### BACKGROUND

### Field of Disclosure

The present disclosure relates to a communications device, infrastructure equipment and methods for performing wireless communications in a wireless communications network.

The present application claims the Paris Convention priority from European Patent Application number EP22170653.4. filed on 28 Apr. 2022. the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example,

different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current agenda includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating an infrastructure equipment of a wireless communications network to perform wireless communications with a communications device via a wireless access interface. The method comprises determining that the infrastructure equipment is to communicate a data transmission with the communications device in time and frequency resources provided by the wireless access interface for the data transmission by either transmitting the data transmission to the communications device as a downlink transmission or receiving the data transmission from the communications device as an uplink transmission. The method comprises identifying a first of at least two portions of the data transmission. The first portion of the data transmission comprises a first portion of the time resources for the data transmission and a first portion of the frequency resources for the data transmission. The method comprises identifying a second of the at least two portions of the data transmission. The second portion of the data transmission comprises a second portion of the time resources for the data transmission and a second portion of the frequency resources of the data transmission. The second portion of the frequency resources for the data transmission are different from the first portion of the frequency resources for the data transmission. The method comprises determining that the first portion of the data transmission is to be communicated according to a modulation scheme and/or a coding scheme which is different from a modulation scheme and/or a coding scheme according to which the second portion of the data transmission is to be communicated. The method comprises performing the communication of the first portion and the second portion of the data transmission. The first portion of the data transmission is communicated according to the modulation scheme and/or coding scheme which is different from the modulation scheme and/or coding scheme according to which the second portion of the data transmission is communicated.

Embodiments can provide a method of operating a communications device to perform wireless communications with an infrastructure equipment of a wireless communications network. The method comprises determining that the communications device is to communicate a data transmission with the infrastructure equipment in time and frequency resources provided by the wireless access interface for the data transmission by either receiving the data transmission from the infrastructure equipment as a downlink transmission or transmitting the data transmission to the infrastructure equipment as an uplink transmission. The method comprises identifying a first of at least two portions of the data transmission. The first portion of the data transmission comprises a first portion of the time resources for the data transmission and a first portion of the frequency resources for the data transmission. The method comprises identifying a second of the at least two portions of the data transmission. The second portion of the data transmission comprises a second portion of the time resources for the data transmission and a second portion of the frequency resources for the data transmission. The second portion of the frequency resources for the data transmission are different from the first portion of the frequency resources for the data transmission. The method comprises determining that the first portion of the data transmission is to be communicated according to a modulation scheme and/or a coding scheme which is different from a modulation scheme and/or a coding scheme according to which the second portion of the data transmission is to be communicated. The method comprises performing the communication of the first portion and the second portion of the data transmission. The first portion of the data transmission is communicated according to the modulation scheme and/or coding scheme which is different from the modulation scheme and/or coding scheme according to which the second portion of the data transmission is communicated.

Embodiments can provide for the use of different modulation and/or coding schemes within the same data transmission and, in particular, within different frequency portions of the same data transmission. As will be appreciated from an understanding of the description below, embodiments can therefore provide increased flexibility in encoding/decoding a data transmission to provide an improved balance between the efficiency and reliability of the data transmission. Example embodiments can further provide improved robustness in encoding/decoding a data transmission to protect against intra-cell interference near sub-band edges.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference;

FIG. 5 illustrates an example approach for accounting for inter-cell cross link interference;

FIG. 6 illustrates an example of code block segmentation;

FIG. 7 schematically illustrates an example of intra-cell cross link interference;

FIG. 8 illustrates an example division of system bandwidth into dedicated uplink and downlink sub-bands;

FIG. 9 illustrates an example of transmission power leakage;

FIG. 10 illustrates an example of receiver power selectivity;

FIG. 11 illustrates adjacent channel interference;

FIG. 12 is a flow diagram illustrating a method performed by an infrastructure equipment in accordance with example embodiments;

FIG. 13 is a flow diagram illustrating a method performed by a communications device in accordance with example embodiments;

FIG. 14 schematically represents an example of non-uniform modulation for an uplink and a downlink transmission in accordance with example embodiments;

FIG. 15 schematically represents an example of non-uniform coding for a downlink transmission in accordance with example embodiments.

### DETAILED DESCRIPTION OF THE EMBODIMENTS

### Long Term Evolution Advanced Radio Access Technology (4G)

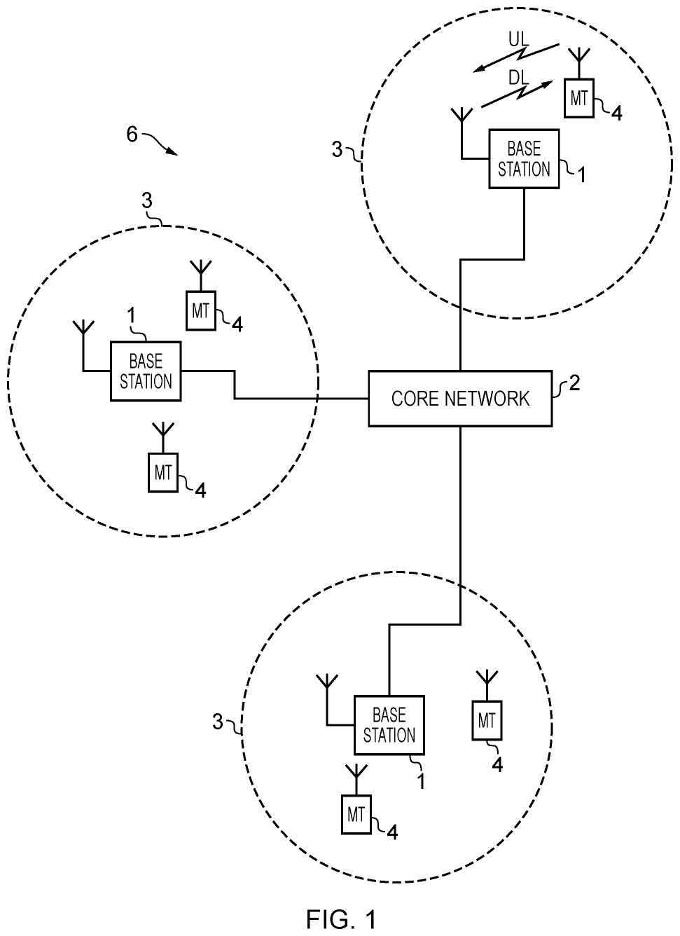

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H, and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL. Data is transmitted from communications devices 4 to the base stations 1 via a radio uplink (UL). The core network 2 routes data to and from the communications devices 4 via the respective base stations 1 and provides functions such as authentication, mobility management. charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

3GPP has completed the basic version of 5G in Rel-15, known as the New Radio Access Technology (NR). In addition, enhancements have been made in Rel-16, incorporating new features such as the 2-step RACH procedure [2]. Industrial Internet of Things (IIoT) [3] and NR-based Access to Unlicensed Spectrum (NR-U) [4].

The NR radio access system employs Orthogonal Frequency Division Multiple Access (OFDMA), where different users are scheduled in different subsets of sub-carriers simultaneously. However, OFDMA requires tight synchronisation in the uplink transmissions in order to achieve orthogonality of transmissions from different users. In essence, the uplink transmissions from all users must arrive at the same time (i.e. they must be synchronised) at the gNB receiver. A UE that is far from the gNB must therefore transmit earlier than a UE closer to the gNB, due to different RF propagation delays. In NR, timing advance commands are applied to control the uplink transmission timing for individual UEs, mainly for Physical Uplink Shared Channels (PUSCHs). Physical Uplink Control Channels (PUCCHs) and Sounding Reference Signals (SRS). The timing advance usually comprises twice the one-way propagation delay between the UE and gNB, thus representing both downlink and uplink delays.

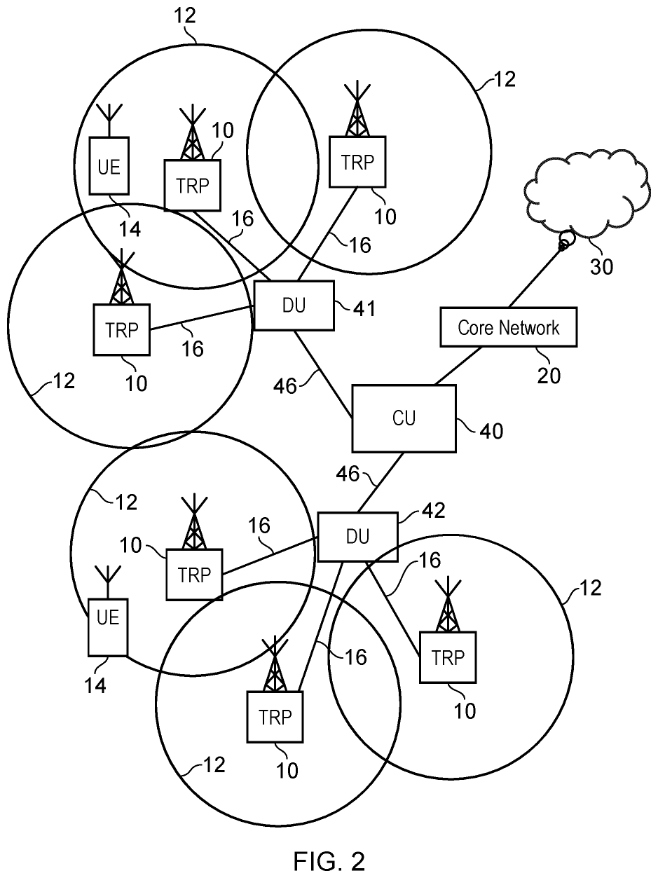

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface (i.e. a radio interface for wireless access) within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

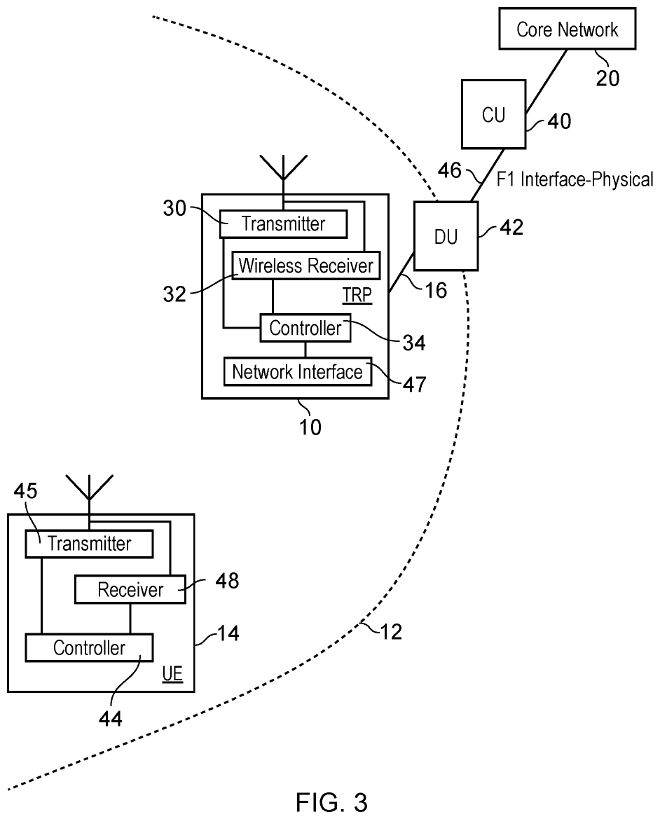

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 45, a receiver 48 and a controller 44 which is configured to control the transmitter 45 and the receiver 48 to transmit signals representing uplink (UL) data to the wireless communications network via the wireless access interface formed by the TRP 10 and to receive downlink (DL) data as signals transmitted by the transmitter 30 and received by the receiver 48 in accordance with the conventional operation.

The transmitters 30, 45 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for case of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 47 which connects to the DU 42 via a physical interface 16. The network interface 47 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 47 of the TRP 10 to the DU 42 and the FI interface 46 from the DU 42 to the CU 40.

### Full Duplex Time Division Duplex (FD-TDD)

NR/5G networks can operate using Time Division Duplexing (TDD), where an entire frequency band is switched to either downlink or uplink transmissions for a time period and can be switched to the other of downlink or uplink transmissions at a later time period. Currently. TDD operates in Half Duplex mode (HD-TDD), where the gNB or UE can, at a given time, either transmit or receive packets, but not both at the same time.

As wireless networks transition from NR to 5G-Advanced networks, a proposed new feature of such networks is to enhance duplexing operation for Time Division Multiplexing (TDD) by enabling Full Duplex operation in TDD (FD-TDD) [5]. In FD-TDD, a gNB can transmit and receive data to and from the UEs at the same time on the same frequency band. In addition, a UE can operate either in HD-TDD or FD-TDD mode, depending on its capability. For example, when UEs are only capable of supporting HD-TDD. FD-TDD is achieved at the gNB by scheduling a DL transmission to a first UE and scheduling an UL transmission to a second UE within the same OFDM symbol (i.e. at the same time). Conversely, when UEs are capable of supporting FD-TDD. FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD, development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, slots are allocated only for either an DL or UL direction in a semi-static manner. Hence, if one direction experiences less or no data, the spare resources cannot be used in the other direction, or are, at best, under-utilized. However, if resources can be used for either DL data or UL data (as in FD-TDD), the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition. UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

With respect to [5] in relation to FD-TDD operation in Rel-18. it is expected that 3GPP will consider only HD-TDD UEs operating together with a FD-TDD gNB. This allows legacy TDD UEs that are Half Duplex to benefit from the FD-TDD operation, which enables complexity to be reduced at the UE to operate in a FD-TDD gNB and furthermore enables the faster introduction of FD-TDD into the market.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL). Uplink (UL) or Flexible (F). An OFDM symbol that is semi-statically configured to be Flexible can be indicated dynamically as DL. UL or remain as Flexible by a Dynamic Slot Format Indicator (SFI), which is transmitted in a Group Common (GC) DCI using DCI Format 2_0, where the CRC of the GC-DCI is masked with SFI-RNTI. Flexible OFDM Symbols that remain Flexible after instruction from the SFI can be changed to a DL symbol or a UL symbol by a DL Grant or a UL Grant respectively. That is, a DL Grant scheduling a Physical Downlink Shared Channel (PDSCH) that overlaps Flexible OFDM Symbols would convert these Flexible OFDM Symbols to DL and similarly an UL Grant scheduling a Physical Uplink Shared Channel (PUSCH) that overlaps Flexible OFDM Symbols would convert these Flexible OFDM Symbols to UL.

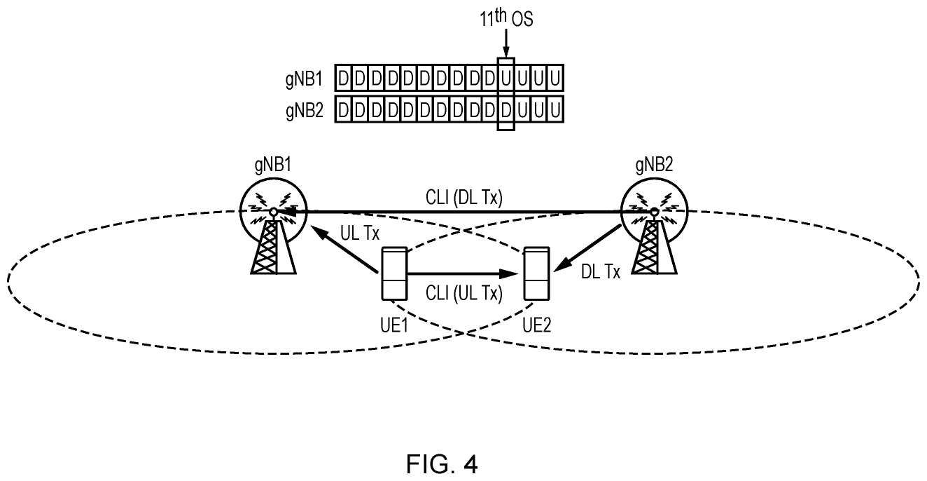

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs. Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 and gNB2 have synchronised slots. At a given slot, gNB1's slot format={D, D, D, D, D, D, D, D, D, D, U, U, U, U} whilst gNB2's slot format={D, D, D, D, D, D, D, D, D, D, D, U, U, U}, where ‘D’ indicates DL and ‘U’ indicates UL. Inter-cell CLI occurs during the 11th OFDM symbol of the slot, where gNB1 is performing UL whilst gNB2 is performing DL. Specifically, inter-cell CLI occurs between gNB1 & gNB2, where gNB2's DL transmission interferes with gNB1's UL reception. CLI also occurs between UE1 & UE2, where UE1's UL transmission interferes with UE2's DL reception.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). For SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

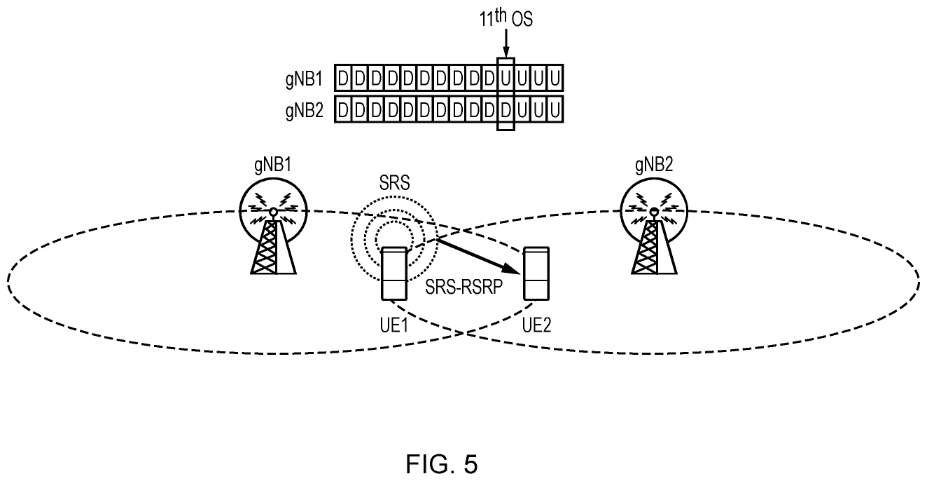

Both SRS-RSRP and CLI-RSSI are RRC measurements are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11th OS of gNB1 and gNB2 causes inter-cell CLI. Here, gNB1 has configured UE1, the aggressor UE, to transmit an SRS and gNB2 has configured UE2, the victim UE, to measure that SRS. UE2 is provided with UE1's SRS configured parameters, e.g.. RS sequence used, frequency resource, frequency transmission comb structure & time resources, so that UE2 can measure the SRS. In general, a UE can be configured to monitor 32 different SRSs, at a maximum rate of 8 SRSs per slot.

For CLI-RSSI measurements, the UE measures the total received power, i.e. signal and interference, following a configured periodicity, start & end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast. CLI-RSSI cannot be used to identify a specific aggressor UE's transmission, but CLI-RSSI does provide an overall estimate of the inter-cell CLI that may be expected to be experienced by the victim UE.

### Code Block Segmentation

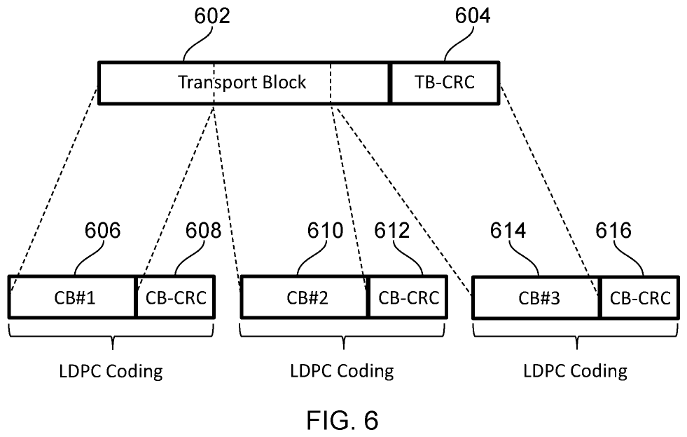

In NR, a transport block for PDSCH or PUSCH can be segmented into multiple Code Blocks (CB) before channel coding. An example is shown in FIG. 6, where a Transport Block (TB) 602 appended with a Transport Block Cyclic Redundancy Check (TB-CRC) 604 is segmented into code blocks. As shown in FIG. 6, the TB 602 and the TB-CRC 604 are segmented into a plurality of code blocks including a first code block (CB #1) 606, a second code block (CB #2) 610 and a third code block (CB #3) 614. A Code Block Cyclic Redundancy Check (CB-CRC) 608, 612, 616 is appended to each one of the respective CBs 606, 610, 614 as shown in FIG. 6. After segmentation, low-density parity check code (LDPC) coding is performed on each CB 606, 610, 614 and its attached CB-CRC 608, 612, 616.

A Code Block Group (CBG) can be formed from one or more CBs, where each CBG can perform HARQ retransmission. Therefore, if only a portion of the TB fails decoding, retransmission of the entire TB can be avoided. In other words, only the CBG containing the failed CBs is retransmitted. Therefore, code block segmentation can reduce communications resources for HARQ retransmissions especially for a large Transport Block Size.

### Intra-Cell Cross Link Interference (CLI)

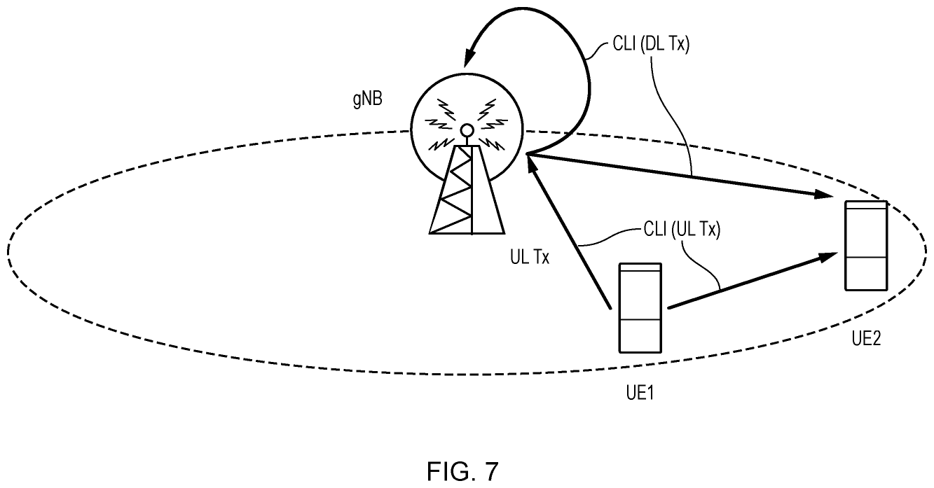

In addition to inter-cell CLI, FD-TDD also suffers from intra-cell CLI at the gNB and at the UE. An example is shown in FIG. 7, where a gNB is capable of FD-TDD and is simultaneously receiving UL transmission from UE1 and transmitting DL transmission to UE2. At gNB1, intra-cell CLI is caused by the DL transmission at the gNB's transmitter self-interfering with its own receiver that is trying to decode UL signals. At the UE, intra-cell CLI is caused by an aggressor UE, e.g.. UE1, transmitting in the UL, whilst a victim UE, e.g.. UE2, is receiving a DL signal.

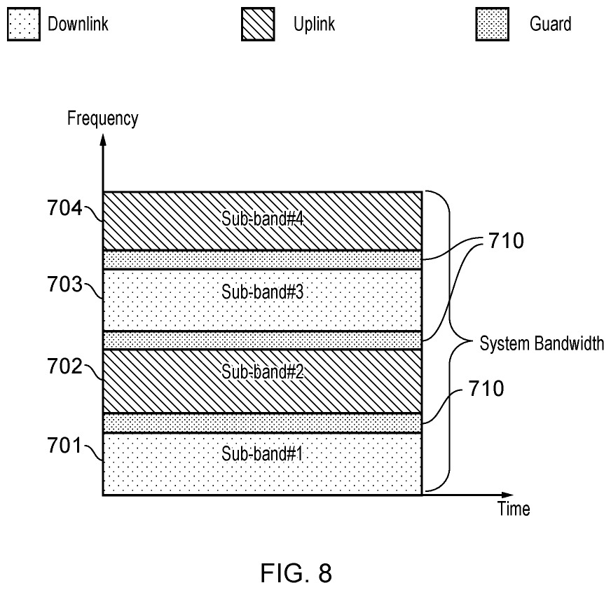

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility is to divide the system (i.e. UE/gNB) bandwidth into non-overlapping sub-bands 701-704, as shown in FIG. 8, where simultaneous DL and UL transmissions occur in different sub-bands 701-704, i.e. in different sets of frequency Resource Blocks (RB).

To reduce leakage from one sub-band 701-704 to another, a guard sub-band 710 may be configured between UL and DL sub-bands 701-704. An example is shown in FIG. 8, where a TDD system bandwidth is divided into 4 sub-bands 701, 702, 703, 704: Sub-band #1 701. Sub-band #2 702. Sub-band #3 703 and Sub-band #4 704 such that Sub-band #1 701 and Sub-band #3 703 are used for DL transmissions, whilst Sub-band #2 702 and Sub-band #4 704 are used for UL transmissions. Guard sub-bands 710 are configured between UL Sub-band #4 704 and DL Sub-band #3 703, between DL Sub-band #3 703 and UL Sub-band #2 702 and between UL Sub-band #2 702 and DL Sub-band #1 701. The arrangement of sub-bands 701-704 shown in FIG. 8 is just one possible arrangement of the sub-bands and other arrangements are possible. For example, such possible arrangements, along with further details on FD-TDD and use of sub-bands may be understood from related documents in the art, such as European patent No. 3545716 [7]. the contents of which are hereby incorporated by reference.

### Adjacent Channel Interference (ACI)

Although a transmission is typically scheduled within a specific frequency channel, i.e. a specific set of

RBs, transmission power can leak out to other channels. This occurs because channel filters are not perfect, and as such the roll-off of the filter will cause power to leak into channels adjacent to the intended specific frequency channel.

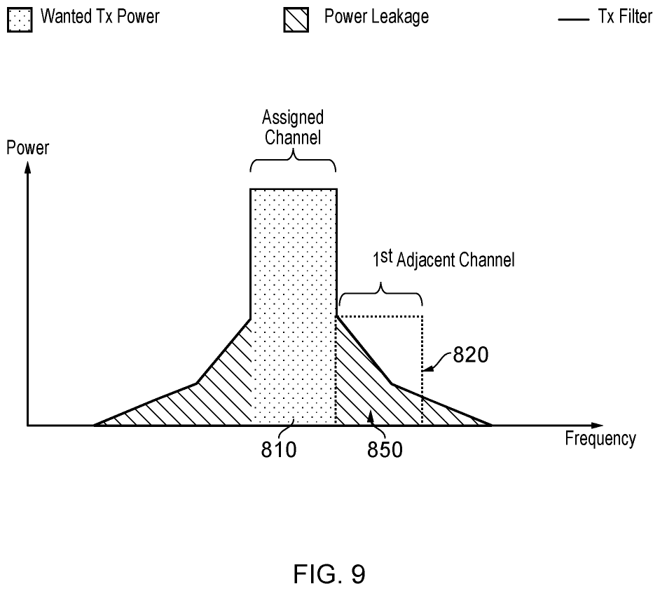

An example of transmission adjacent channel leakage is shown in FIG. 9. Here, the wanted transmission (Tx) power is the transmission power in the selected frequency band (i.e. the assigned channel 810). Due to roll-off of the transmission filter, some transmission power is leaked into adjacent channels (including an adjacent channel 820), as shown in FIG. 9. The ratio of the power within the assigned frequency channel 810 to the power in the adjacent channel 820 is the Adjacent Channel Leakage Ratio (ACLR). The leakage power 850 will cause interference at a receiver that is receiving the signal at the adjacent channels 820.

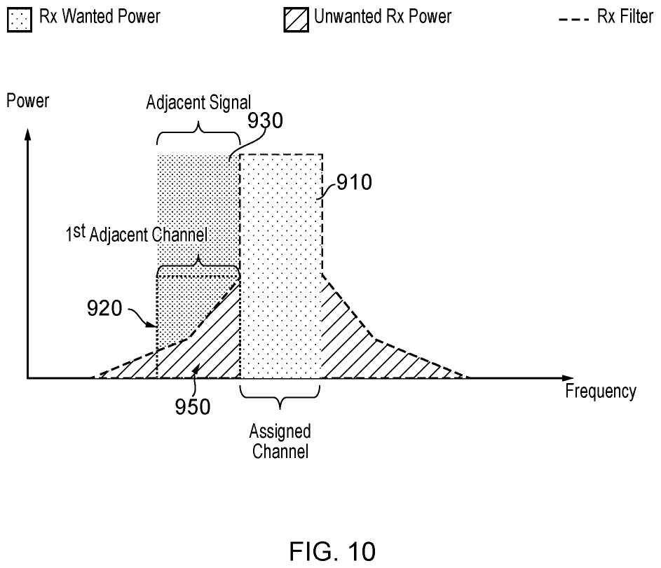

Similarly, a receiver's filter is also not perfect and will receive unwanted power from adjacent channels due to its own filter roll-off. An example of filter roll-off at a receiver is shown in FIG. 10. Here, a receiver is configured to receive transmissions in an assigned channel 910, however the imperfect nature of the receiver filter means that some transmission power 950 can be received in an adjacent channel 920. Therefore, if a signal 930 is transmitted on the adjacent channel 920, the receiver will inadvertently receive the adjacent signal 930 in the adjacent channel 920, to an extent. The ratio of the received power in the assigned frequency channel 910 to the received power 950 in the adjacent channel 920 is the Adjacent Channel Selectivity (ACS).

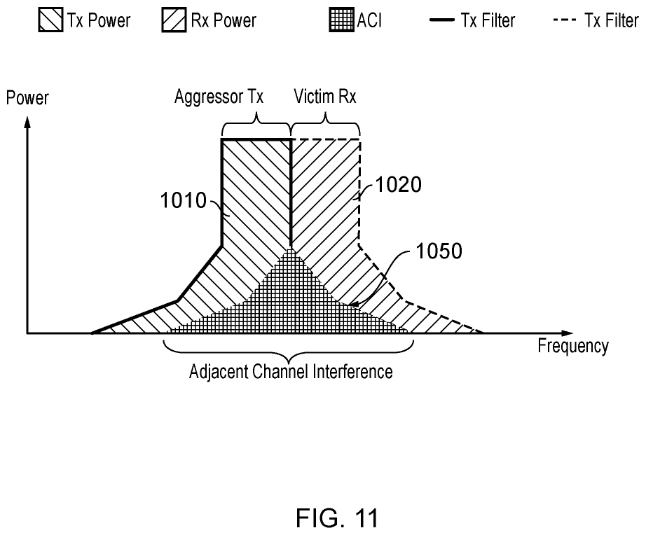

The combination of the ACL from the transmitter and the ACS of a receiver will lead to adjacent channel interference (ACI) at the receiver. An example is shown in FIG. 11, where an aggressor transmits a signal 1010 in an adjacent channel at a lower frequency than the victim's receiving 1020 channel. The interference 1050 caused by the aggressor's transmission includes the ACL of the aggressor's transmitting filter and the ACS of the victim's receiving filter. In other words, the receiver will experience interference 1050 in the ACI frequency range shown in FIG. 11.

As such, due to adjacent channel interference (ACI), cross link interference (CLI) will still occur despite the use of different sub-bands 701-704 for DL and UL transmissions in a FD-TDD cell. Hence, new methods are required to manage ACI in FD-TDD employing sub-bands. Embodiments of the present disclosure seek to provide such methods.

### Non-Uniform MCS for FD-TDD

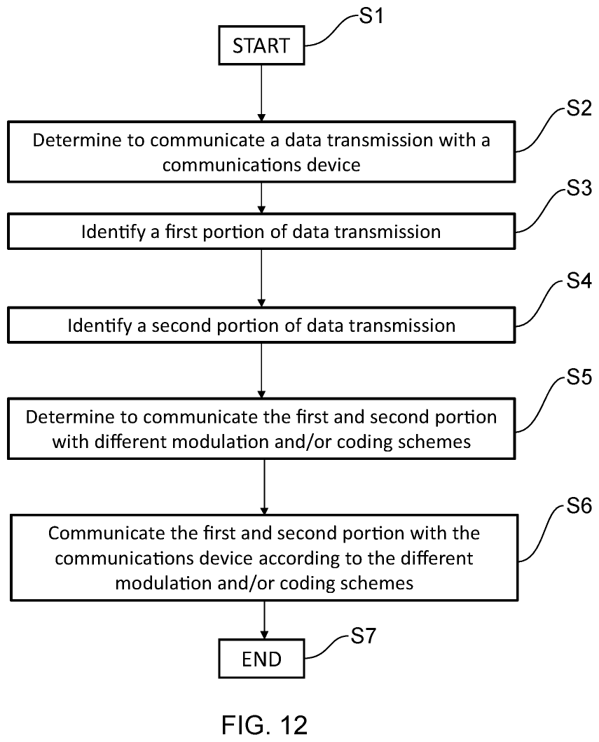

FIG. 12 shows a flow diagram illustrating a method of operating an infrastructure equipment of a wireless communications network to perform wireless communications with a communications device via a wireless access interface. The method starts in step S1.

In step S2, the infrastructure equipment determines that it is to communicate a data transmission with the communications device in time and frequency resources provided by the wireless access interface for the data transmission by either transmitting the data transmission to the communications device as a downlink transmission or receiving the data transmission from the communications device as an uplink transmission. In other words, the data transmission may be a downlink transmission or an uplink transmission. The phrase “data transmission” is to be construed as referring to any transmission of data such as user data and/or control data. In some embodiments, the data transmission may be alternatively be referred to as the transmission of a communications channel. For example, a data transmission may be a transmission of PDSCH, PDCCH, PUCCH or PUSCH. The wireless access interface may be any interface suitable for wireless communications between the infrastructure equipment and communications device. For example, the wireless interface may be a radio interface such as a Uu interface between a gNB (which is an example of infrastructure equipment) and a UE (which is an example of a communications device). In some embodiments, the determining that the infrastructure equipment is to communicate the data transmission may comprise the infrastructure equipment scheduling the data transmission.

In step S3, the infrastructure equipment identifies a first of at least two portions of the data transmission. The first portion of the data transmission comprises a first portion of the time resources for the data transmission and a first portion of the frequency resources for the data transmission. In some embodiments, the identifying of the first portion of the data transmission may comprise identifying the first portion for use with a particular modulation scheme and/or coding scheme.

In some embodiments, where the data transmission is a downlink transmission, and the frequency resources are located in a downlink region of the wireless access interface, the first portion may be identified based on how close the frequency resources for the downlink transmission are to an uplink region of the wireless access interface. For example, the infrastructure equipment may set a frequency threshold distance from the uplink region such that if frequency resources of the downlink transmission are below or equal to the frequency threshold distance, those frequency resources form part of the first portion of the downlink transmission. In some embodiments, the downlink region of the wireless access interface is a downlink sub-band.

In some embodiments, where the data transmission is an uplink transmission, and the frequency resources are located in an uplink region of the wireless access interface, the first portion may be identified based on how close the frequency resources for the uplink transmission are to a downlink region of the wireless access interface. For example, the infrastructure equipment may set a frequency threshold distance from the downlink region such that if frequency resources of the uplink transmission are below or equal to the frequency threshold distance, those frequency resources form part of the first portion of the uplink transmission. In some embodiments, the uplink region of the wireless access interface is an uplink sub-band.

The infrastructure equipment may set the frequency threshold distance based on prevailing interference conditions. For example, if the infrastructure equipment detects a decrease in signal-to-noise ratio (SINR), then it may increase the frequency threshold distance.

In step S4, the infrastructure equipment identifies a second of the at least two portions of the data transmission. The second portion of the data transmission comprises a second portion of the time resources for the data transmission and a second portion of the frequency resources of the data transmission. The second portion of the frequency resources for the data transmission are different from the first portion of the frequency resources for the data transmission. The first portion of time resources of the data transmission and the second portion of the time resources of the data transmission may be the same, different or partially overlap. Therefore the first portion and the second portion may comprise overlapping time resources but non-overlapping frequency resources. For example, the first portion and the second portion may comprise different frequency resources within one or more OFDM symbols on which the data transmission is communicated. In some embodiments, the frequency resources for the first portion and the second portion do not overlap at all, while in other embodiments the frequency resources for the first and second portion overlap partially. In some embodiments, the identifying of the second portion of the data transmission may comprise identifying the second portion for use with a particular modulation scheme and/or coding scheme at least one of which is different from the modulation scheme and coding scheme used for the first portion of the data transmission.

In some embodiments, where the data transmission is a downlink transmission, and the frequency resources are located in a downlink region of the wireless access interface, the second portion may be identified based on how close the frequency resources for the downlink transmission are to an uplink region of the wireless access interface. In such embodiments, the second portion of the data transmission may be further from the uplink region than the first portion of the data transmission. For example, the infrastructure equipment may determine that if frequency resources of the downlink transmission are above the frequency threshold distance from the uplink region, then those frequency resources form part of the second portion of the downlink transmission. In some embodiments, the downlink region of the wireless access interface is a downlink sub-band.

In some embodiments, where the data transmission is an uplink transmission, and the frequency resources are located in an uplink region of the wireless access interface, the second portion may be identified based on how close the frequency resources for the uplink transmission are to a downlink region of the wireless access interface. In such embodiments, the second portion of the data transmission may be further from the downlink region than the first portion of the data transmission. For example, the infrastructure equipment may determine that if frequency resources of the uplink transmission are above the frequency threshold distance from the downlink region, then those frequency resources form part of the second portion of the uplink transmission. In some embodiments, the uplink region of the wireless access interface is an uplink sub-band.

In some embodiments, the data transmission may be comprised only of the first and second portion of the data transmission. For example, the time and frequency resources for the first portion and the time and frequency resources for the second portion together form the time and frequency resources for the overall data transmission. In some embodiments, the data transmission may comprise one or more other portions in addition to the first and second portions, where each portion comprises a portion of the time resources for the data transmission and a portion of the frequency resources for the data transmission. In such embodiments, the one or more other portions may be communicated according to a modulation and/or coding scheme which is the same or different from the modulation and/or coding scheme according to which the first or second portion of the data transmission is communicated. For example, the data transmission may comprise a third portion which is communicated according to the same modulation and/or coding scheme as the first portion. In another example, the data transmission may comprise a third portion which is communicated according to the same modulation and/or coding scheme as the second portion. In another example, the data transmission may comprise a third portion which is communicated according to a different modulation and/or coding scheme than either of the first or the second portion.

In some embodiments, the infrastructure equipment may set a frequency threshold distance for identifying each portion of the data transmission.

In step S5, the infrastructure equipment determines that the first portion of the data transmission is to be communicated according to a modulation scheme and/or a coding scheme which is different from a modulation scheme and/or a coding scheme according to which the second portion of the data transmission is to be communicated. In some embodiments, the first portion and the second portion may be communicated according to the same modulation scheme but a different coding scheme. In some embodiments, the first portion and the second portion may be communicated according to the same coding scheme but a different modulation scheme. In some embodiments, the first portion and the second portion may be communicated according to a different modulation scheme and a different coding scheme.

The phrase “modulation scheme” for a data transmission is to be construed as meaning a method of modulating the data transmission. As will be appreciated by one skilled in the art, different modulation schemes may have different “orders”. A higher order modulation scheme may use a larger number of constellation points for encoding/decoding bits than a lower order modulation scheme. As such, higher order modulation schemes can more efficiently encode/decode bits for transmission. However, due to the increased number of constellation points per symbol, higher order modulation schemes also have a decreased reliability or robustness. Examples of modulation schemes in arranged in descending order are: 256 Quadrature Amplitude Modulation (QAM), 64 QAM and Quadrature Phase Shift keying (QPSK). The phrase “coding scheme” for a data transmission is to be construed a method of encoding/decoding the data transmission. As will be appreciated by one skilled in the art, different coding schemes may have different coding rates. As such, coding schemes with higher coding rates may have a data transmission rate that is faster than coding schemes with lower coding rates. However, an increased coding rate may reduce the reliability of the encoding/decoding of the data transmission. As will be known to one skilled in the art, modulation and coding schemes may be referred to using an “MCS” index. For example, a modulation and coding scheme denoted by an MCS index of “5” has a higher respective modulation order and coding rate than a modulation and coding scheme denoted by an MCS index of “1”. The phrase “non-uniform Modulation and Coding Scheme (MCS)” for a data transmission is to be construed as meaning that at least one of the modulation and coding scheme for the first portion of the data transmission is different from the modulation and coding scheme for the second portion of the data transmission.

In step S6, the infrastructure equipment performs the communication of the first portion and the second portion of the data transmission. The first portion of the data transmission is communicated according to the modulation scheme and/or coding scheme which is different from the modulation scheme and/or coding scheme according to which the second portion of the data transmission is communicated. In some embodiments, the performing of the communication may comprise transmitting the first and second portion as part of the overall data transmission as a downlink transmission. In such embodiments, the performing the communication may comprise encoding the first portion and the second portion of the data transmission according to their respective modulation and coding schemes. In some embodiments, the performing of the communication may comprise receiving the first and second portion as part of the overall data transmission as an uplink transmission. In such embodiments, the performing the communication may comprise decoding the first portion and the second portion of the data transmission according to their respective modulation and coding schemes.

The method ends in step S7.

Those skilled in the art would appreciate that the method shown by FIG. 12 may be adapted in accordance with embodiments of the present technique. For example, other intermediate steps may be included in this method, or the steps may be performed in any logical order. For example, steps S3, S4 and S5 may be performed in any order or at the same time as part of the same processing step. In a particular example, the infrastructure equipment may identify the first and second portions as part of mapping frequency resources of the data transmission to different modulation and coding schemes.

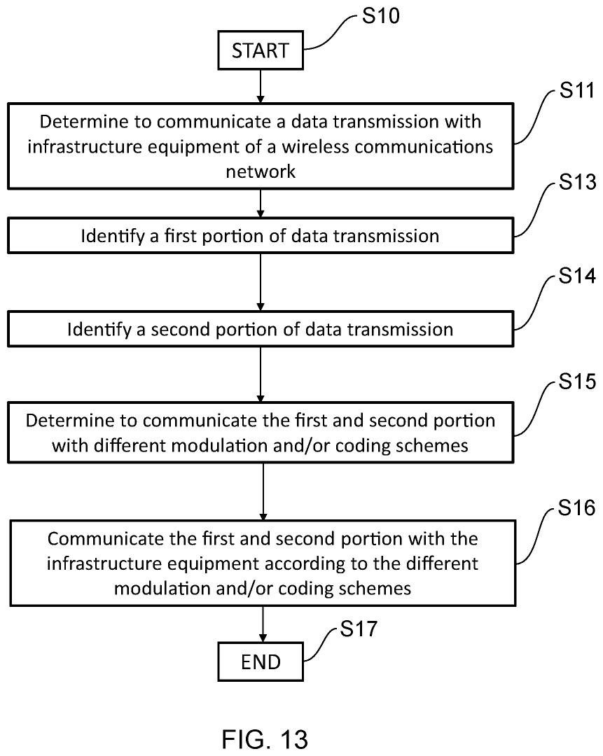

FIG. 13 shows a flow diagram illustrating a method of operating a communications device to perform wireless communications with an infrastructure equipment of a wireless communications network via a wireless access interface. The method starts in step S10.

In step S11, the communications device determines that it is to communicate a data transmission with the infrastructure equipment in time and frequency resources provided by the wireless access interface for the data transmission by either receiving the data transmission from the infrastructure equipment as a downlink transmission or transmitting the data transmission to the infrastructure equipment as an uplink transmission. In other words, the data transmission may be a downlink transmission or an uplink transmission. In some embodiments, the determining that the communications is to communicate the data transmission may be based on scheduling information received from the infrastructure equipment which schedules the data transmission.

In step S13, the communications device identifies a first of at least two portions of the data transmission. The first portion of the data transmission comprises a first portion of the time resources for the data transmission and a first portion of the frequency resources for the data transmission. In some embodiments, the identifying of the first portion of the data transmission may comprise identifying the first portion for use with a particular modulation scheme and/or coding scheme.

In some embodiments, where the data transmission is a downlink transmission, and the frequency resources are located in a downlink region of the wireless access interface, the first portion may be identified based on how close the frequency resources for the downlink transmission are to an uplink region of the wireless access interface. For example, the communications device may receive, from the infrastructure equipment, an indication of a frequency threshold distance from the uplink region. In such embodiments, if frequency resources of the downlink transmission are below or equal to the frequency threshold distance, the communications device determines that those frequency resources form part of the first portion of the downlink transmission.

In some embodiments, where the data transmission is an uplink transmission, and the frequency resources are located in an uplink region of the wireless access interface, the first portion may be identified based on how close the frequency resources for the uplink transmission are to a downlink region of the wireless access interface. For example, the communications device may receive, from the infrastructure equipment, an indication of a frequency threshold distance from the downlink region. In such embodiments, if frequency resources of the uplink transmission are below or equal to the frequency threshold distance, the communications device determines that those frequency resources form part of the first portion of the uplink transmission.

In step S14, the communications device identifies a second portion of the data transmission. The second portion of the data transmission comprises a second portion of the time resources for the data transmission and a second portion of the frequency resources for the data transmission. The second portion of the frequency resources for the data transmission are different from the first portion of the frequency resources for the data transmission. The first portion of time resources of the data transmission and the second portion of the time resources of the data transmission may be the same, different or partially overlap. Therefore the first portion and the second portion may comprise overlapping time resources but non-overlapping frequency resources. For example, the first portion and the second portion may comprise different frequency resources within one or more OFDM symbols on which the data transmission is communicated. In some embodiments, the frequency resources for the first portion and the second portion do not overlap at all, while in other embodiments the frequency resources for the first and second portion overlap partially. In some embodiments, the identifying of the second portion of the data transmission may comprise identifying the second portion for use with a particular modulation scheme and/or coding scheme at least one of which is different from the modulation scheme and coding scheme used for the first portion of the data transmission.

In some embodiments, where the data transmission is a downlink transmission, and the frequency resources are located in a downlink region of the wireless access interface, the second portion may be identified based on how close the frequency resources for the downlink transmission are to an uplink region of the wireless access interface. In such embodiments, the second portion of the data transmission may be further from the uplink region than the first portion of the data transmission. For example, the communications device may determine that if frequency resources of the downlink transmission are above the frequency threshold distance from the uplink region received from the infrastructure equipment, then those frequency resources form part of the second portion of the downlink transmission.

In some embodiments, where the data transmission is an uplink transmission, and the frequency resources are located in an uplink region of the wireless access interface, the second portion may be identified based on how close the frequency resources for the uplink transmission are to a downlink region of the wireless access interface. In such embodiments, the second portion of the data transmission may be further from the downlink region than the first portion of the data transmission. For example, the communications device may determine that if frequency resources of the uplink transmission are above the frequency threshold distance from the downlink region received from the infrastructure equipment, then those frequency resources form part of the second portion of the uplink transmission.

In some embodiments, the communications device may receive a non-uniform MCS indicator (as will be explained in more detail below). The non-uniform MCS indicator may include an indication of the time and frequency resources of the first and second portion of the data transmission as determined by the infrastructure equipment, and the communications device may identify the first and second portion of the data transmission based on the indication.

In some embodiments, the data transmission may be comprised only of the first and second portion of the data transmission. In some embodiments, the data transmission may comprise one or more other portions in addition to the first and second portions. In such embodiments, the communications may receive a frequency threshold distance, or an indication in the non-uniform MCS indicator, for identifying each portion of the data transmission.

In step S15, the communications device determines that the first portion of the data transmission is to be communicated according to a modulation scheme and/or a coding scheme which is different from a modulation scheme and/or a coding scheme according to which the second portion of the data transmission is to be communicated. In some embodiments, the first portion and the second portion may be communicated according to the same modulation scheme but a different coding scheme. In some embodiments, the first portion and the second portion may be communicated according to the same coding scheme but a different modulation scheme. In some embodiments, the first portion and the second portion may be communicated according to a different modulation scheme and a different coding scheme.

In step S16, the communications device performs the communication of the first portion and the second portion of the data transmission. The first portion of the data transmission is communicated according to the modulation scheme and/or coding scheme which is different from the modulation scheme and/or coding scheme according to which the second portion of the data transmission is communicated. In some embodiments, the performing of the communication may comprise receiving the first and second portion as part of the overall data transmission as a downlink transmission. In such embodiments, the performing the communication may comprise decoding the first portion and the second portion of the data transmission according to their respective modulation and coding schemes. In some embodiments, the performing of the communication may comprise transmitting the first and second portion as part of the overall data transmission as an uplink transmission. In such embodiments, the performing the communication may comprise encoding the first portion and the second portion of the data transmission according to their respective modulation and coding schemes.

The method ends in step S17.

Those skilled in the art would appreciate that the method shown by FIG. 13 may be adapted in accordance with embodiments of the present technique. For example, other intermediate steps may be included in this method, or the steps may be performed in any logical order. For example, steps S13, S14 and S15 may be performed in any order or at the same time as part of the same processing step. In a particular example, the communications device may identify the first and second portions as part of mapping frequency resources of the data transmission to different modulation and coding schemes.

As will be understood by one skilled in the art, higher order modulation schemes can provide increased encoding/decoding efficiency at the expense of reliability whereas coding schemes with higher encoding/decoding rates come at the expense of decreased reliability. Accordingly, there is a trade-off between which modulation and/or coding scheme should be used for a particular transmission-in circumstances where reliability is less significant, a higher order modulation scheme and a higher coding rate scheme is desirable to improve encoding/decoding efficiency and speed. Conversely, in circumstances where reliability is more significant, a lower order modulation scheme and a lower coding rate scheme is desirable to improve encoding/decoding reliability which may avoid the need for retransmissions.

Example embodiments can provide for the use of different modulation and/or coding schemes within the same data transmission and, in particular, within different frequency portions of the same data transmission. Therefore, example embodiments can provide increased flexibility in encoding/decoding a data transmission to provide an improved balance between the efficiency and reliability of the data transmission.

Furthermore, as explained previously, intra-cell CLI caused by ACI may be prevalent near the edge of a sub-band containing a data transmission when an adjacent sub-band has a different link direction. In accordance with some embodiments, and as will be understood more fully by an appreciation of the following description, the portion of the data transmission which is closer to the edge of a sub-band can be mapped to a lower order modulation scheme and/or a coding scheme with a lower encoding/decoding rate. In other words, the portion of the data transmission closer to the edge of the sub-band is provided with a modulation and/or coding scheme with increased reliability or robustness. Therefore, the portion of the data transmission closer to the sub-band edge has increased protection against interference while the other portion(s) of the data transmission, which are less susceptible to interference, can use a higher modulation and/or coding scheme to maintain high levels of efficiency.

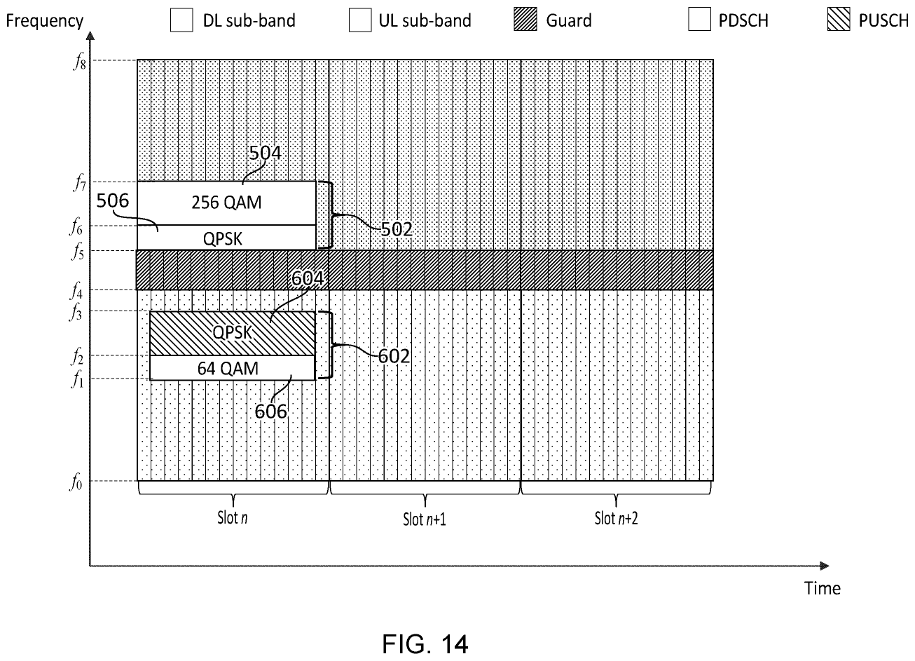

An example of a non-uniform modulation an uplink and a downlink transmission is illustrated in FIG. 14. As shown in FIG. 14, a wireless access interface comprising a TDD bandwidth spanning frequencies f₀ to fₛ is divided into an uplink sub-band spanning frequencies f₀ to f₄, a downlink sub-band spanning frequencies f₅ to fₛ and a guard sub-band between the uplink sub-band and the downlink sub-band, and spanning frequencies f₄ to f₅. In this example, a gNB schedules, in slot n, a downlink transmission 502 to a UE and an uplink transmission 602 to another UE. In the example shown in FIG. 14, the downlink transmission 502 is a PDCSH transmission and the uplink transmission 602 is a PUSCH transmission. The uplink transmission 602 occupies frequencies f₁ to f₃ and the downlink transmission 502 occupies frequencies f₅ to f₇. In accordance with example embodiments, the gNB identifies a first portion 506 of the downlink transmission 502 and a second portion 504 of the downlink transmission 502. The first portion 506 of the downlink transmission 502 occupies frequencies between f₅ to f₆ and the second portion 504 of the downlink transmission 502 occupies frequencies between f₆ to f₇. Therefore the first portion 506 of the downlink transmission 502 is closer to the uplink sub-band than the second portion 504 of the downlink transmission 502. In accordance with the example embodiments, the gNB communicates the first portion 506 of the downlink transmission 502 according to a lower order modulation scheme than the second portion 504 of the downlink transmission 502. For example, the gNB may communicate the first portion 506 of the downlink transmission 502 according to a Quadrature Phase Shift Keying (QPSK) modulation scheme and communicate the second portion 504 of the downlink transmission 502 according to a 256 Quadrature Amplitude Modulation (QAM) scheme. This skilled person will understand that the 256 QAM scheme is a higher order modulation scheme than the QPSK scheme. In some embodiments, the first portion 506 of the downlink transmission 502 may also be communicated according to a coding scheme with a lower coding rate than the coding scheme with which the second portion 504 of the downlink transmission 502 is communicated.

By using a lower modulation and/or coding scheme for the first portion 506 of the downlink transmission 502 closer to the uplink sub-band than for the second portion of 504 of the downlink transmission that is further from the uplink sub-band, the first portion 506 of the downlink transmission 502, which is more susceptible to ACI, is provided with more robust encoding which can therefore reduce the effects of interference.

In accordance with example embodiments, the gNB identifies a first portion 604 of the uplink transmission 602 and a second portion 606 of the uplink transmission 602. The first portion 604 of the uplink transmission 602 occupies frequencies between f₂ to f₃ and the second portion 606 of the uplink transmission 602 occupies frequencies between f₁ to f₂. Therefore the first portion 604 of the uplink transmission 602 is closer to the downlink sub-band than the second portion 606 of the uplink transmission. In accordance with the example embodiments, the gNB communicates the first portion 604 of the uplink transmission 602 according to a lower order modulation scheme than the second portion 606 of the uplink transmission 602. For example, the gNB may communicate the first portion 604 of the uplink transmission 602 according to a QPSK modulation scheme and communicate the second portion 606 of the uplink transmission 602 according to a 64 QAM scheme. This skilled person will understand that the 64 QAM scheme is a higher order modulation scheme than the QPSK scheme. In some embodiments, the first portion 604 of the uplink transmission 602 may also be communicated according to a coding scheme with a lower coding rate than the coding scheme with which the second portion 606 of the uplink transmission 602 is communicated.

By using a lower modulation and/or coding for the first portion 604 of the uplink transmission 602 that is closer to the downlink sub-band than the second portion 606 of the uplink transmission 602 that is further from the downlink sub-band, the first portion 604 of the uplink transmission 602 can be transmitted with a lower transmission power than the second portion 606 of the uplink transmission, thereby enabling non-uniform power control across the uplink transmission 502. A first portion 604 being received at the gNB may suffer from higher ACI due to the gNB's downlink transmission than the second portion 602 and by encoding the first portion with lower modulation and/or coding enables the first portion to be more robust against ACI at the gNB's receiver. Furthermore, by using a lower modulation and/or coding for the first portion 604 of the uplink transmission 602 that is closer to the downlink sub-band than the second portion 606 of the uplink transmission 602 that is further from the downlink sub-band, the first portion 604 of the uplink transmission 602, which is more susceptible to ACI at the gNB's receiver that is also performing downlink transmission, or more likely to cause ACI to another UE performing downlink reception, is provided with more robust encoding which can therefore reduce the effects of interference.

In example embodiments, the gNB performs code block segmentation for a data transmission (such as an uplink or downlink transmission). For example, a transport block is divided into a plurality of coding blocks and each coding block is encoded/decoded according to a different modulation and/or coding scheme. In some embodiments, each code block may be encoded/decoded according to different coding rates.

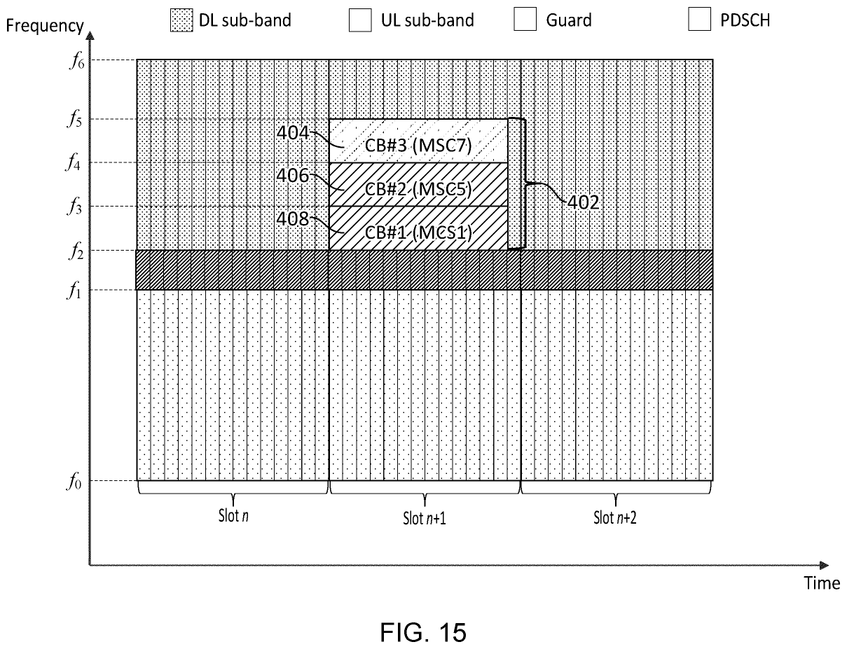

An example of non-uniform coding for a downlink transmission is shown in FIG. 15. As shown in FIG. 15, a transport block of a downlink transmission 402 is divided into a plurality of code blocks 404, 406, 408 by code block segmentation. In this example, the downlink transmission 402 is a PDSCH. The plurality of code blocks 404, 406, 408 comprise a first code block (CB #1) 408, a second code block (CB #2) 406 and a third code block (CB #3) 404. In some embodiments, the first 408, second 406 and third 404 code blocks represent a first, second and third portion of the downlink transmission 402 respectively. As shown in FIG. 15, a different modulation and coding scheme (MCS) is used for each of the code blocks 404, 406, 408. In particular. MCS 1 is used for the first code block 408. MCS 5 is used for the second code block 406 and MCS 7 is used for the third code block 404. As will be appreciated by those acquainted with MCS terminology, the numbers following the MCS acronym (e.g. 1, 5 and 7) represent an “MCS index”. A lower MCS index means a lower order modulation scheme and/or a lower coding rate. As explained previously, a lower modulation and coding rate can provide for increased robustness. As shown in FIG. 15, a downlink sub-band spanning frequencies f₂ to f₆ and an uplink sub-band spanning frequencies f₀ to f₁ are separated by a guard-band spanning frequencies f₁ to f₂.

As shown in FIG. 15, the first code block 408 is mapped to frequencies f₂ to f₃, the second code block 406 is mapped to frequencies f₃ to f₄ and the third code block 404 is mapped to frequencies f₄ to f₅. Therefore, the first code block 408, with the lowest MCS index is at an edge of the downlink sub-band closest to the uplink sub-band whereas the third code block 404, with the highest MCS index, is furthest away from the edge of the downlink sub-band closest to the uplink sub-band.

Therefore, code blocks with lower coding rates and/or modulation order are mapped to frequency resources (for example, resource elements) that are closer to the sub-band edge while code blocks with higher coding rates and/or modulation order are mapped to frequency resources that are further away from the sub-band edge. In other words, different code blocks can have different modulation order and/or coding rate and the gNB can map the most robust code blocks closer to the sub-band edge that is susceptible to intra-cell CLI due to ACI.

Although example embodiments described with reference to FIG. 15 has been described with respect to non-uniform MCS for a downlink transmission, it will be appreciated that such embodiments are equally applicable to uplink transmissions such as PUSCH or PUCCH.

In example embodiments embodiment, the gNB may identify one or more systematic bits and one or more parity bits in the data transmission (such as an uplink or a downlink transmission). The gNB may allocate the one or more parity bits to the first portion of the data transmission and allocate the one or more systematic bits to the second portion of the data transmission, where the first portion is closer to the sub-band edge than the second portion. In other words, systematic bits are mapped to resource elements that are less susceptible to intra-UE CLI caused by ACI whilst parity bits are mapped to resource elements that are more susceptible to ACI. As will be appreciated by one skilled in the art, systematic bits are more important for reliable decoding than parity bits. Therefore, by mapping the systematic bits to resource elements that are less susceptible to interference, then encoding/decoding reliability can be improved.

### Non-Uniform MCS Indicator

In example embodiments, a gNB may transmit a non-uniform MCS indicator to a UE to indicate that at least one of the modulation scheme or the coding scheme for the first portion of the data transmission is different from the modulation scheme or the coding scheme for the second portion of the data transmission. In other words, the gNB transmits an indication of whether non-uniform MCS is used. In this way, the gNB can control when non-uniform MCS should be used based on, for example, whether intra-cell CLI caused by ACI is expected.

In some embodiments, the non-uniform MCS indicator indicates the modulation scheme and/or the coding scheme to be used for communicating the first and/or the second portion of the data transmission. For example, the non-uniform MCS indicator may indicate a plurality of MCS index values to be used for encoding/decoding a data transmission. If non-uniform MCS is enabled, a different resource element mapping is used such that the first portion of the data transmission that has robust MCS is mapped to frequency resources that are susceptible to or cause intra-cell CLI due to ACI whilst the second portion of the data transmission that has less robust MCS is mapped to frequency resources that are less susceptible to or cause less ACI.

In some embodiments, the non-uniform MCS indicator is transmitted to the UE along with scheduling information which comprises an indication of the time resources and the frequency resources for the data transmission. For example, the non-uniform MCS may be transmitted in downlink control information, DCI, which provides an uplink or downlink grant which grants the time and frequency resources for the data transmission.

In some embodiments, the gNB transmits an indication of a set of grant-free resources (such as a PUSCH or SPS configuration). In such embodiments, the non-uniform MCS indicator may be transmitted in the activation DCI which activates one or more instances of the set of grant-free resources to use for the data transmission.

In some embodiments where the non-uniform MCS indicator is indicated in the activation DCI, the non-uniform MCS is only applicable to the first X_{PUSCH} CG-PUSCH occasions or X_{SPS} SPS occasions, after which, the legacy uniform MCS is used. The value X_{PUSCH} and X_{SPS} can be RRC configured, indicated in the activation DCI or fixed in the specifications (e.g. X_{PUSCH}=1 and X_{SPS}=1).

In some embodiments, the non-uniform MCS indicator is indicated in a Group Common DCI (GC-DCI). In such embodiments, the GC-DCI may be sent to a plurality of UEs.

In some embodiments, the non-uniform MCS parameters, such as different MCS index values and resource element mapping schemes are RRC configured. The enabling and disabling of non-uniform MCS can also be perform via RRC configuration or it can be further indicated dynamically using DCI or GC-DCI.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may, without departing from the scope of the claims, form part of communications systems other than those defined by the present disclosure.

The following numbered paragraphs provide further example aspects and features of the present technique:

Paragraph 1. A method of operating an infrastructure equipment of a wireless communications network to perform wireless communications with a communications device via a wireless access interface, the method comprising
determining that the infrastructure equipment is to communicate a data transmission with the communications device in time and frequency resources provided by the wireless access interface for the data transmission by either transmitting the data transmission to the communications device as a downlink transmission or receiving the data transmission from the communications device as an uplink transmission,
identifying a first of at least two portions of the data transmission, the first portion comprising a first portion of the time resources for the data transmission and a first portion of the frequency resources for the data transmission,
identifying a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determining that the first portion of the data transmission is to be communicated according to a modulation scheme and/or a coding scheme which is different from a modulation scheme and/or a coding scheme according to which the second portion of the data transmission is to be communicated, and
performing the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

Paragraph 2. A method according to paragraph 1, wherein the wireless access interface is divided into a plurality of frequency regions comprising
an uplink region providing frequency resources for receiving uplink transmissions,
a downlink region providing frequency resources for transmitting downlink transmissions, wherein
the frequency resources for the data transmission are located in either the uplink region or the downlink region,
the first portion of the data transmission is closer to the other of the uplink region or the downlink region than the second portion of the data transmission, and
at least one of the modulation scheme and the coding scheme for the first and second portion of the data transmission depend on a distance of the first and second portion of the data transmission from the other of the uplink or downlink region.

Paragraph 3. A method according to paragraph 2, wherein the wireless access interface comprises a guard region between the uplink region and the downlink region.

Paragraph 4. A method according to paragraph 2 or paragraph 3, wherein
the modulation scheme for the first portion of the data transmission has a lower order than the modulation scheme for the second portion of the data transmission.

Paragraph 5. A method according to any of paragraphs 2 to 4, wherein
the coding scheme for the first portion of the data transmission has a lower coding rate than the coding scheme for the second portion of the data transmission.

Paragraph 6. A method according to any of paragraphs 2 to 5, wherein the identifying the first portion and the second portion of the data transmission comprises
determining an Adjacent Channel Interference, ACI, level of the frequency resources of the data transmission

Paragraph 7. A method according to paragraph 6, wherein the determining the ACI of the frequency resources of the data transmission comprises
receiving one or more measurement reports from the communications device.
determining the ACI level based on the one or more measurement reports received from the communications device, and
identifying the first and the second portion of the data transmission based on the determined ACI level.

Paragraph 8. A method according to any of paragraphs 2 to 7, wherein the identifying the first portion and the second portion of the data transmission comprises
identifying the first and the second portion of the data transmission based a respective distance of the first and second portion of the data transmission from the other of the uplink or the downlink region.

Paragraph 9. A method according to paragraph 8, wherein the identifying the first and the second portion of the data transmission based a respective distance of the first and second portion of the data transmission from the other of the uplink or the downlink region comprises
determining that the frequency resources of the first portion of the downlink transmission are below or equal to a frequency distance threshold from the other of the uplink or the downlink region, and
determining that the frequency resources of the second portion of the downlink transmission above a frequency distance threshold from the other of the uplink or the downlink region.

Paragraph 10. A method according to paragraph 9, comprising
receiving one or more reference signals from the communications device,
determining an interference level based on the one or more reference signals received from the communications device, and
setting the frequency threshold distance based on the determined interference level.

Paragraph 11. A method according to any of paragraphs 2 to 10, wherein the data transmission comprises a transport block, the method comprising
dividing the transport block into at least two sets of code blocks, each set of code blocks comprising one or more code blocks, wherein,
a first of the at least two sets of code blocks is the first portion of the data transmission, and
a second of the at least two sets of code blocks is the second portion of the data transmission.

Paragraph 12. A method according to any of paragraphs 2 to 11, comprising
identifying one or more systematic bits and one or more parity bits in the data transmission,
allocating the one or more parity bits to the first portion of the data transmission, and
allocating the one or more systematic bits to the second portion of the data transmission.

Paragraph 13. A method according to any of paragraphs 2 to 12, wherein the data transmission is a downlink transmission and the time and frequency resources of the downlink transmission are located in the downlink region, the method comprising
determining that the infrastructure equipment is to receive an uplink transmission from another communications device in time and frequency resources provided by the uplink region of the wireless access interface for the uplink transmission,
identifying a first portion of at least two portions of the uplink transmission, the first portion of the uplink transmission comprising a first portion of the time resources for the uplink transmission and a first portion of the frequency resources for the uplink transmission,
identifying a second of the at least two portions of the uplink transmission, the second portion of the uplink transmission comprising a second portion of the time resources for the uplink transmission and a second portion of the frequency resources of the uplink transmission, the second portion of the frequency resources for the uplink transmission being different from the first portion of the frequency resources for the uplink transmission,
determining that the first portion of the uplink transmission is to be communicated according to a modulation scheme and/or a coding scheme which is different from a modulation scheme and/or a coding scheme according to which the second portion of the uplink transmission is to be communicated, and
receiving the first portion and the second portion of the uplink transmission, the first portion of the uplink transmission being received according to the modulation scheme and/or coding scheme which is different from the modulation scheme and/or coding scheme according to which the second portion of the uplink transmission is received.

Paragraph 14. A method according to paragraph 13, wherein,
the first portion of the uplink transmission is closer to the downlink region than the second portion of the uplink transmission.

Paragraph 15. A method according to paragraph 14, wherein the time resources for the uplink transmission overlap at least partially with the time resources for the downlink transmission.

Paragraph 16. A method according to any of paragraphs 1 to 15, comprising
transmitting a non-uniform Modulation and Coding Scheme. MCS, indicator to the communications device indicating that at least one of the modulation scheme or the coding scheme for the first portion of the data transmission is different from the modulation scheme or the coding scheme for the second portion of the data transmission.

Paragraph 17. A method according to paragraph 16, wherein the non-uniform MCS indicator indicates the modulation scheme and/or the coding scheme to be used for communicating the first and/or the second portion of the data transmission.

Paragraph 18. A method according to paragraph 16 or paragraph 17, wherein the transmitting the non-uniform MCS indicator to the communications device comprises
transmitting the non-uniform MCS indicator to the communications device along with scheduling information, the scheduling information comprising at least an indication of the time resources and the frequency resources for the data transmission.

Paragraph 19. A method according to paragraph 18, wherein the transmitting the non-uniform MCS indicator along with the scheduling information comprises transmitting the MCS in downlink control information, DCI, the DCI comprising
an uplink grant indicating the scheduling information for the data transmission if the data transmission is an uplink transmission, or
a downlink grant indicating the scheduling information for the data transmission if the data transmission is a downlink transmission.

Paragraph 20. A method according to paragraph 18, wherein the transmitting the non-uniform MCS indicator along with the scheduling information comprises
transmitting an indication of a set of grant-free resources, and
transmitting the non-uniform MCS indicator in activation downlink control information, DCI, the activation DCI indicating at least one instance of the set of grant-free resources to use for the data transmission.

Paragraph 21. A method according to paragraph 20, wherein the transmitting the non-uniform MCS indicator along with the scheduling information comprises
transmitting an indication that the non-uniform MCS indicator does not apply to one or more subsequent data transmissions to be communicated in the set of grant free resources.

Paragraph 22. A method according to paragraph 21, wherein the indication that the non-uniform MCS indicator does not apply to one or more subsequent data transmissions to be communicated in the set of grant-free resources is transmitted as a Radio Resource Control, RRC, signal.

Paragraph 23. A method according to paragraph 21, wherein the indication that the non-uniform MCS indicator does not apply to one or more subsequent data transmissions to be communicated in the set of grant free resources is transmitted in the activation DCI.

Paragraph 24. A method according to any of paragraphs 20 to 23, wherein the transmitting the indication of the set of grant-free resources comprises
transmitting a semi-persistent scheduling, SPS, configuration, or
transmitting a configuration for a Physical Uplink Scheduling Channel, PUSCH.

Paragraph 25. A method according to paragraph 16 or paragraph 17, wherein the transmitting the non-uniform MCS indicator to the communications device comprises
transmitting the non-uniform MCS indicator in Group-Common Downlink Control Information, GC-DCI.

Paragraph 26. A method according to paragraph 16 or paragraph 17, wherein the transmitting the non-uniform MCS indicator to the communications device comprises
transmitting the non-uniform MCS indicator in a Radio Resource Control, RRC, signal.

Paragraph 27. A method according to any of paragraphs 1 to 26, wherein the first portion of the time resources for the data transmission and the second portion of the time resources for the data transmission overlap at least partially in time.

Paragraph 28. A method of operating a communications device to perform wireless communications with an infrastructure equipment of a wireless communications network, the method comprising
determining that the communications device is to communicate a data transmission with the infrastructure equipment in time and frequency resources provided by the wireless access interface for the data transmission by either receiving the data transmission from the infrastructure equipment as a downlink transmission or transmitting the data transmission to the infrastructure equipment as an uplink transmission,
identifying a first of at least two portions of the data transmission, the first portion comprising a first portion of the time resources for the data transmission and a first portion of the frequency resources for the data transmission,
identifying a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determining that the first portion of the data transmission is to be communicated according to a modulation scheme and/or a coding scheme which is different from a modulation scheme and/or a coding scheme according to which the second portion of the data transmission is to be communicated, and
performing the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

Paragraph 29. A method according to paragraph 28, wherein the wireless access interface is divided into a plurality of frequency regions comprising
an uplink region providing frequency resources for transmitting uplink transmissions,
a downlink region providing frequency resources for receiving downlink transmissions, wherein
the frequency resources for the data transmission are located in either the uplink region or the downlink region,
the first portion of the data transmission is closer to the other of the uplink region or the downlink region than the second portion of the data transmission, and
at least one of the modulation scheme and the coding scheme for the first and second portion of the data transmission depend on a distance of the first and second portion of the data transmission from the other of the uplink or downlink region.

Paragraph 30. A method according to paragraph 29, wherein the wireless access interface comprises a guard region between the uplink region and the downlink region.

Paragraph 31. A method according to paragraph 29 or paragraph 30, wherein
the modulation scheme for the first portion of the data transmission has a lower order than the modulation scheme for the second portion of the data transmission.

Paragraph 32. A method according to any of paragraphs 29 to 31, wherein
the coding scheme for the first portion of the data transmission has a lower coding rate than the coding scheme for the second portion of the data transmission.

Paragraph 33. A method according to any of paragraphs 29 to 32, wherein the identifying the first portion and the second portion of the data transmission comprises
determining an Adjacent Channel Interference, ACI, level of the frequency resources of the data transmission

Paragraph 34. A method according to paragraph 33, wherein the determining the ACI of the frequency resources of the data transmission comprises
receiving one or more measurement reports from the infrastructure equipment,
determining the ACI level based on the one or more measurement reports received from the communications device, and
identifying the first and the second portion of the data transmission based on the determined ACI level.

Paragraph 35. A method according to any of paragraphs 29 to 34, wherein the identifying the first portion and the second portion of the data transmission comprises
identifying the first and the second portion of the data transmission based a respective distance of the first and second portion of the data transmission from the other of the uplink or the downlink region.

Paragraph 36. A method according to paragraph 35, wherein the identifying the first and the second portion of the data transmission based a respective distance of the first and second portion of the data transmission from the other of the uplink or the downlink region comprises
determining that the frequency resources of the first portion of the downlink transmission are below or equal to a frequency distance threshold from the other of the uplink or the downlink region, and
determining that the frequency resources of the second portion of the downlink transmission above a frequency distance threshold from the other of the uplink or the downlink region.

Paragraph 37. A method according to any of paragraphs 29 to 36, wherein the data transmission comprises a transport block, the method comprising
dividing the transport block into at least two sets of code blocks, each set of code blocks comprising one or more code blocks, wherein,
a first of the at least two sets of code blocks is the first portion of the data transmission, and
a second of the at least two sets of code blocks is the second portion of the data transmission.

Paragraph 38. A method according to any of paragraphs 29 to 37, comprising
identifying one or more systematic bits and one or more parity bits in the data transmission,
allocating the one or more parity bits to the first portion of the data transmission, and
allocating the one or more systematic bits to the second portion of the data transmission.

Paragraph 39. A method according to any of paragraphs 28 to 38, comprising
receiving a non-uniform Modulation and Coding Scheme. MCS, indicator from the infrastructure equipment indicating that at least one of the modulation scheme or the coding scheme for the first portion of the data transmission is different from the modulation scheme or the coding scheme for the second portion of the data transmission.

Paragraph 40. A method according to paragraph 39, wherein the non-uniform MCS indicator indicates the modulation scheme and/or the coding scheme to be used for communicating the first and/or the second portion of the data transmission.

Paragraph 41. A method according to paragraph 39 or paragraph 40, wherein the MCS indicator comprises an indication of the time and frequency resources of the first portion and the second portion of the data transmission, and the first and second portion of the data transmission are identified based on the non-uniform MCS indicator.

Paragraph 42. A method according to paragraph 39 or paragraph 40, wherein the receiving the non-uniform MCS indicator from the infrastructure equipment comprises
receiving the non-uniform MCS indicator from the infrastructure equipment along with scheduling information, the scheduling information comprising at least an indication of the time resources and the frequency resources for the data transmission.

Paragraph 43. A method according to paragraph 42, wherein the receiving the non-uniform MCS indicator along with the scheduling information comprises receiving the MCS in downlink control information. DCI, the DCI comprising
an uplink grant indicating the scheduling information for the data transmission if the data transmission is an uplink transmission, or
a downlink grant indicating the scheduling information for the data transmission if the data transmission is a downlink transmission.

Paragraph 44. A method according to paragraph 42, wherein the receiving the non-uniform MCS indicator along with the scheduling information comprises
receiving an indication of a set of grant-free resources, and
receiving the non-uniform MCS indicator in activation downlink control information, DCI, the activation DCI indicating at least one instance of the set of grant-free resources to use for the data transmission.

Paragraph 45. A method according to paragraph 44, wherein the receiving the non-uniform MCS indicator along with the scheduling information comprises
receiving an indication that the non-uniform MCS indicator does not apply to one or more subsequent data transmissions to be communicated in the set of grant-free resources.

Paragraph 46. A method according to paragraph 45, wherein the indication that the non-uniform MCS indicator does not apply to one or more subsequent data transmissions to be communicated in the grant-free resources is received as a Radio Resource Control, RRC, signal.

Paragraph 47. A method according to paragraph 45, wherein the indication that the non-uniform MCS indicator does not apply to one or more subsequent data transmissions to be communicated in the grant-free resources is received in the activation DCI.

Paragraph 48. A method according to any of paragraphs 44 to 47, wherein the receiving the indication of the set of grant-free resources comprises
receiving a semi-persistent scheduling. SPS, configuration, or
receiving a configuration for a Physical Uplink Scheduling Channel, PUSCH.

Paragraph 49. A method according to paragraph 39 or paragraph 40, wherein the receiving the MCS from the infrastructure equipment comprises
transmitting the non-uniform MCS indicator in Group-Common Downlink Control Information, GC-DCI.

Paragraph 50. A method according to paragraph 39 or paragraph 40, wherein the receiving the non-uniform MCS indicator from the infrastructure equipment comprises
receiving the non-uniform MCS indicator in a Radio Resource Control, RRC, signal.

Paragraph 51. A method according to any of paragraphs 28 to 50, wherein the first portion of the time resources for the data transmission and the second portion of the time resources for the data transmission overlap at least partially in time.

Paragraph 52. An infrastructure equipment of a wireless communications network operable to perform wireless communications with a communications device via a wireless access interface, the infrastructure equipment comprising
a transmitter configured to transmit signals,
a receiver configured to receive signals, and
a controller configured in combination with the transmitter and the receiver to
determine that the infrastructure equipment is to communicate a data transmission with the communications device in time and frequency resources provided by the wireless access interface for the data transmission by either transmitting the data transmission to the communications device as a downlink transmission or receiving the data transmission from the communications device as an uplink transmission,
identify a first of at least two portions of the data transmission, the first portion comprising a first portion of the time resources for the data transmission and a first portion of the frequency resources for the data transmission,
identify a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determine that the first portion of the data transmission is to be communicated according to a modulation scheme and/or a coding scheme which is different from a modulation scheme and/or a coding scheme according to which the second portion of the data transmission is to be communicated, and
perform the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

Paragraph 53. A communications device operable to perform wireless communications with an infrastructure equipment of a wireless communications network, the communications device comprising
a transmitter configured to transmit signals,
a receiver configured to receive signals, and
a controller configured in combination with the transmitter and the receiver to
determine that the communications device is to communicate a data transmission with the infrastructure equipment in time and frequency resources provided by the wireless access interface for the data transmission by either receiving the data transmission from the infrastructure equipment as a downlink transmission or transmitting the data transmission to the infrastructure equipment as an uplink transmission,
identify a first of at least two portions of the data transmission, the first portion comprising a first portion of the time resources for the data transmission and a first portion of the frequency resources for the data transmission,
identify a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determine that the first portion of the data transmission is to be communicated according to a modulation scheme and/or a coding scheme which is different from a modulation scheme and/or a coding scheme according to which the second portion of the data transmission is to be communicated, and
perform the communication of the first portion and the second portion of the data transmission. wherein the first portion of the data transmission is communicated according to the modulation scheme and/or coding scheme which is different from the modulation scheme and/or coding scheme according to which the second portion of the data transmission is communicated.

Paragraph 54. Circuitry for an infrastructure equipment of a wireless communications network operable to perform wireless communications with a communications device via a wireless access interface, the circuitry comprising
transmitter circuitry configured to transmit signals,
receiver circuitry configured to receive signals, and
controller circuitry configured in combination with the transmitter circuitry and the receiver circuitry to
determine that the infrastructure equipment is to communicate a data transmission with the communications device in time and frequency resources provided by the wireless access interface for the data transmission by either transmitting the data transmission to the communications device as a downlink transmission or receiving the data transmission from the communications device as an uplink transmission,

identify a first of at least two portions of the data transmission, the first portion comprising a first portion of the time resources for the data transmission and a first portion of the frequency resources for the data transmission,
identify a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determine that the first portion of the data transmission is to be communicated according to a modulation scheme and/or a coding scheme which is different from a modulation scheme and/or a coding scheme according to which the second portion of the data transmission is to be communicated, and
perform the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

Paragraph 55. Circuitry for a communications device operable to perform wireless communications with an infrastructure equipment of a wireless communications network, the circuitry comprising
transmitter circuitry configured to transmit signals,
receiver circuitry configured to receive signals, and
controller circuitry configured in combination with the transmitter circuitry and the receiver circuitry to
determine that the communications device is to communicate a data transmission with the infrastructure equipment in time and frequency resources provided by the wireless access interface for the data transmission by either receiving the data transmission from the infrastructure equipment as a downlink transmission or transmitting the data transmission to the infrastructure equipment as an uplink transmission,
identify a first of at least two portions of the data transmission, the first portion comprising a first portion of the time resources for the data transmission and a first portion of the frequency resources for the data transmission,
identify a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determine that the first portion of the data transmission is to be communicated according to a modulation scheme and/or a coding scheme which is different from a modulation scheme and/or a coding scheme according to which the second portion of the data transmission is to be communicated, and
perform the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

Paragraph 56. A wireless communications network comprising a communications device according to paragraph 53 and infrastructure equipment according to paragraph 52.

Paragraph 57. A computer program comprising instructions which, when loaded onto a computer, cause the computer to perform a method according to any of paragraphs 1 to 51.

Paragraph 58. A non-transitory computer-readable storage medium storing a computer program according to paragraph 57.

It will be appreciated that the above description for clarity has described embodiments with reference to steps performed by a communications device or steps performed by an infrastructure equipment. However, it will be apparent that steps performed by a communications device may be performed by a controller/controller circuitry of the communications device in combination with a transmitter/transmitter circuitry and/or receiver/receiver circuitry of the communications device. Similarly, it will be apparent that steps performed by an infrastructure equipment may be performed by a controller/controller circuitry of the infrastructure equipment in combination with a transmitter/transmitter circuitry and/or receiver/receiver circuitry of the infrastructure equipment.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H, and Toskala A, “LTE for UMTS OFDMA and SC-FDMA based radio access”, John Wiley and Sons, 2009.

[2] RP-192330, “New work item: 2-step RACH for NR,” ZTE Corporation, 3GPP TSG RAN Meeting #85.

[3] RP-192324, “Revised WID: Support of NR Industrial Internet of Things (IoT),” Nokia, Nokia Shanghai Bell, 3GPP TSG RAN Meeting #85.

[4] RP-191575, “NR-based Access to Unlicensed Spectrum,” Qualcomm, Inc., 3GPP TSG RAN Meeting #84.

[5] RP-220633, “Revised SID: Study on evolution of NR duplex operation,” CMCC, RAN #95-e.

[6] TS38.213, “Physical layer procedures for control (Release 17)”.

[7] European patent No. 3545716.

1. A method of operating an infrastructure equipment of a wireless communications network to perform wireless communications with a communications device via a wireless access interface, the method comprising
determining that the infrastructure equipment is to communicate a data transmission with the communications device in time and frequency resources provided by the wireless access interface for the data transmission by either transmitting the data transmission to the communications device as a downlink transmission or receiving the data transmission from the communications device as an uplink transmission,
identifying a first of at least two portions of the data transmission, the first portion comprising a first portion of the time resources for the data transmission and a first portion of the frequency resources for the data transmission,
identifying a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determining that the first portion of the data transmission is to be communicated according to a modulation scheme and/or a coding scheme which is different from a modulation scheme and/or a coding scheme according to which the second portion of the data transmission is to be communicated, and
performing the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

2. A method according to claim 1, wherein the wireless access interface is divided into a plurality of frequency regions comprising
an uplink region providing frequency resources for receiving uplink transmissions,
a downlink region providing frequency resources for transmitting downlink transmissions, wherein
the frequency resources for the data transmission are located in either the uplink region or the downlink region,
the first portion of the data transmission is closer to the other of the uplink region or the downlink region than the second portion of the data transmission, and
at least one of the modulation scheme and the coding scheme for the first and second portion of the data transmission depend on a distance of the first and second portion of the data transmission from the other of the uplink or downlink region.

3. A method according to claim 2, wherein the wireless access interface comprises a guard region between the uplink region and the downlink region.

4. A method according to claim 2, wherein
the modulation scheme for the first portion of the data transmission has a lower order than the modulation scheme for the second portion of the data transmission.

5. A method according to claim 2, wherein
the coding scheme for the first portion of the data transmission has a lower coding rate than the coding scheme for the second portion of the data transmission.

6. A method according to claim 2, wherein the identifying the first portion and
the second portion of the data transmission comprises determining an Adjacent Channel Interference, ACI, level of the frequency resources of the data transmission

7. A method according to claim 6, wherein the determining the ACI of the frequency resources of the data transmission comprises
receiving one or more measurement reports from the communications device,
determining the ACI level based on the one or more measurement reports received from the communications device, and
identifying the first and the second portion of the data transmission based on the determined ACI level.

8. A method according to claim 2, wherein the identifying the first portion and the second portion of the data transmission comprises
identifying the first and the second portion of the data transmission based a respective distance of the first and second portion of the data transmission from the other of the uplink or the downlink region.

9. A method according to claim 8, wherein the identifying the first and the second portion of the data transmission based a respective distance of the first and second portion of the data transmission from the other of the uplink or the downlink region comprises
determining that the frequency resources of the first portion of the downlink transmission are below or equal to a frequency distance threshold from the other of the uplink or the downlink region, and
determining that the frequency resources of the second portion of the downlink transmission above a frequency distance threshold from the other of the uplink or the downlink region.

10. A method according to claim 9, comprising
receiving one or more reference signals from the communications device,
determining an interference level based on the one or more reference signals received from the communications device, and
setting the frequency threshold distance based on the determined interference level.

11. A method according to claim 2, wherein the data transmission comprises a transport block, the method comprising
dividing the transport block into at least two sets of code blocks, each set of code blocks comprising one or more code blocks, wherein,
a first of the at least two sets of code blocks is the first portion of the data transmission, and
a second of the at least two sets of code blocks is the second portion of the data transmission.

12. A method according to claim 2, comprising
identifying one or more systematic bits and one or more parity bits in the data transmission,
allocating the one or more parity bits to the first portion of the data transmission, and allocating the one or more systematic bits to the second portion of the data transmission.

13. A method according to claim 2, wherein the data transmission is a downlink transmission and the time and frequency resources of the downlink transmission are located in the downlink region, the method comprising
determining that the infrastructure equipment is to receive an uplink transmission from another communications device in time and frequency resources provided by the uplink region of the wireless access interface for the uplink transmission,
identifying a first portion of at least two portions of the uplink transmission, the first portion of the uplink transmission comprising a first portion of the time resources for the uplink transmission and a first portion of the frequency resources for the uplink transmission,
identifying a second of the at least two portions of the uplink transmission, the second portion of the uplink transmission comprising a second portion of the time resources for the uplink transmission and a second portion of the frequency resources of the uplink transmission, the second portion of the frequency resources for the uplink transmission being different from the first portion of the frequency resources for the uplink transmission,
determining that the first portion of the uplink transmission is to be communicated according to a modulation scheme and/or a coding scheme which is different from a modulation scheme and/or a coding scheme according to which the second portion of the uplink transmission is to be communicated, and
receiving the first portion and the second portion of the uplink transmission, the first portion of the uplink transmission being received according to the modulation scheme and/or coding scheme which is different from the modulation scheme and/or coding scheme according to which the second portion of the uplink transmission is received.

14. A method according to claim 13, wherein,
the first portion of the uplink transmission is closer to the downlink region than the second portion of the uplink transmission.

15. A method according to claim 14, wherein the time resources for the uplink transmission overlap at least partially with the time resources for the downlink transmission.

16. A method according to claim 1, comprising
transmitting a non-uniform Modulation and Coding Scheme, MCS, indicator to the communications device indicating that at least one of the modulation scheme or the coding scheme for the first portion of the data transmission is different from the modulation scheme or the coding scheme for the second portion of the data transmission.

17. A method according to claim 16, wherein the non-uniform MCS indicator indicates the modulation scheme and/or the coding scheme to be used for communicating the first and/or the second portion of the data transmission.

18. A method according to claim 16, wherein the transmitting the non-uniform MCS indicator to the communications device comprises
transmitting the non-uniform MCS indicator to the communications device along with scheduling information, the scheduling information comprising at least an indication of the time resources and the frequency resources for the data transmission.

19.-51. (canceled)

52. An infrastructure equipment of a wireless communications network operable to perform wireless communications with a communications device via a wireless access interface, the infrastructure equipment comprising
a transmitter configured to transmit signals,
a receiver configured to receive signals, and
a controller configured in combination with the transmitter and the receiver to
determine that the infrastructure equipment is to communicate a data transmission with the communications device in time and frequency resources provided by the wireless access interface for the data transmission by either transmitting the data transmission to the communications device as a downlink transmission or receiving the data transmission from the communications device as an uplink transmission,
identify a first of at least two portions of the data transmission, the first portion comprising a first portion of the time resources for the data transmission and a first portion of the frequency resources for the data transmission,
identify a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determine that the first portion of the data transmission is to be communicated according to a modulation scheme and/or a coding scheme which is different from a modulation scheme and/or a coding scheme according to which the second portion of the data transmission is to be communicated, and
perform the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

53. A communications device operable to perform wireless communications with an infrastructure equipment of a wireless communications network, the communications device comprising
a transmitter configured to transmit signals,
a receiver configured to receive signals, and
a controller configured in combination with the transmitter and the receiver to
determine that the communications device is to communicate a data transmission with the infrastructure equipment in time and frequency resources provided by the wireless access interface for the data transmission by either receiving the data transmission from the infrastructure equipment as a downlink transmission or transmitting the data transmission to the infrastructure equipment as an uplink transmission,
identify a first of at least two portions of the data transmission, the first portion comprising a first portion of the time resources for the data transmission and a first portion of the frequency resources for the data transmission,
identify a second of the at least two portions of the data transmission, the second portion comprising a second portion of the time resources for the data transmission and a second portion of the frequency resources for the data transmission, the second portion of the frequency resources for the data transmission being different from the first portion of the frequency resources for the data transmission,
determine that the first portion of the data transmission is to be communicated according to a modulation scheme and/or a coding scheme which is different from a modulation scheme and/or a coding scheme according to which the second portion of the data transmission is to be communicated, and
perform the communication of the first portion and the second portion of the data transmission, wherein the first portion of the data transmission is communicated according to the modulation scheme and/or coding scheme which is different from the modulation scheme and/or coding scheme according to which the second portion of the data transmission is communicated.

54.-58. (canceled)
